(19) United States
(12) Patent Application Publication
(10) Pub. No.: US 2002/0069028 A1
(43) Pub. Date: Jun. 6, 2002

(54) System and method for supporting aware goods

(76) Inventors: Christian Merz, Waldkirch (DE); Oliver Frick, Karlsruhe (DE); Albrecht Schmidt, Karlsruhe (DE); Hans-Werner Gellersen, Groetzingen (DE)

Correspondence Address: FINNEGAN, HENDERSON, FARABOW, GARRETT &, DUNNER LLP, 1300 I STREET, NW, WASHINGTON, DC, 20005, US

(21) Appl. No.: 09/729,914

(22) Filed: Dec. 4, 2000

(51) Int. Cl. G06M 11/04

(52) U.S. Cl. 702/127

(57) ABSTRACT

The conditions to which objects are subjected to over a period of time are monitored by placing a sensing device in or near the object which is of concern. This sensing device senses a relevant environmental parameter (for example heat, humidity, light, radiation, acceleration, etc.) at periodic intervals and records an indication of the magnitude of the environmental parameter. The sensing device is read by a computer input device, and the logged environmental data is downloaded onto a computer connected with a computer data network having at least one web server. The log data from the computer is sent over the data network to the server and a script on the server converts the data into an appropriate format data file, and transmits it to a business computer.

### FIELD OF THE INVENTION

This invention relates to the field of monitoring products as they are processed or transported, and especially to a system for monitoring the environment that goods are subjected to during processing or transport.

### DISCUSSION OF PRIOR ART

As is well known, goods that are sensitive to environmental factors, e.g., temperature, are commonly processed within a facility or they are transported, sometimes substantial distances, between locations, especially between the seller and the buyer. Examples of such perishable goods are various types of food, medical materials which are vulnerable to changes in temperature, and also many chemicals which can easily deteriorate when conditions are not optimal.

Conventionally when goods are perishable or vulnerable to environmental influences, the seller has a transport specification which defines the nature and quality of transport which is appropriate for the goods. The seller provides with the goods that are shipped from his installation a quality certificate that represents that the goods were of acceptable quality when they left his control.

Subsequently, the buyer receives the goods, relying primarily on the carrier for having transported them appropriately. Unfortunately, even where the workers handling goods, or the carrier transporting them, are very careful, environmental factors such as sudden rises in temperature, physical shocks, leakage, humidity, etc., can harm the goods.

The prior art offers no way of monitoring what happens to vulnerable goods during their transport, except by fairly uninformative methods, such as the simple physical sealing of a door of a refrigerated railroad car, for instance.

### SUMMARY OF THE INVENTION

It is therefore an object of the invention to provide for a system of monitoring the conditions to which objects are subjected, particularly while they are being processed or transported.

According to the system of the present invention, the environmental conditions to which objects are subjected over a period of time are monitored by placing a sensing device in or near the object which is of concern. This sensing device is movable with the object and senses a relevant environmental parameter (for example heat, humidity, light, radiation, acceleration, etc.) at periodic intervals and records an indication of the magnitude of the environmental parameter sensed. This indication data is stored in a memory log in the sensing device, and then, at some point after processing (e.g., when the buyer receives the product), the sensing device is read by a computer input device, and the logged environmental data is downloaded onto a computer.

According to an aspect of the invention, the receiving computer is connected with a computer data network having at least one web server. When the log data is received, the computer accesses this web server so as to cause a script to run thereon. The log data from the computer is sent over the data network and the script on the server converts this data file into a suitable format for transmission over the network, preferably, a markup language format data file, such as an XML file. The web server then transmits the markup language format data file of the logged environmental data to a business computer that records or otherwise processes this information for appropriate administration of this object as part of its general data.

Preferably, the business system that receives the data transmitted from the web server comprises a business communications processor connected with an enterprise management system, e.g., a backend Enterprise Resource Planning (ERP) business control system, which can efficiently process and store data for a large number of articles in process, and which can provide display information to a user relating to the type of material in the object, its environmental parameters, and information regarding associated articles, such as those in the same shipment.

Other objects and advantages of the present invention will become apparent from the specification herein.

### BRIEF DESCRIPTION OF THE DRAWINGS

FIG. 1 shows a schematic of the overall system by which the environmental influences on a product can be monitored using the systems and methods of the present invention.

FIG. 2 is a schematic diagram of a sensor device as used in the preferred embodiment.

FIG. 3 is a flowchart showing the cooperation of the various parts of the system.

FIG. 4 shows a sample display screen for data derived for an object processed according to the invention.

FIG. 5 shows a sample HTML display screen mode available from the server according to the present invention.

### DETAILED DESCRIPTION

Handling and shipment of perishable, vulnerable or fragile goods presents a number of problems with respect to any damage thereto. Potentially, for example, a seller could be blamed for deterioration of goods which were actually damaged in transit by carrier who is responsible for the damage. The present system provides for “aware goods” in an intelligent supply chain which overcomes this potential problem.

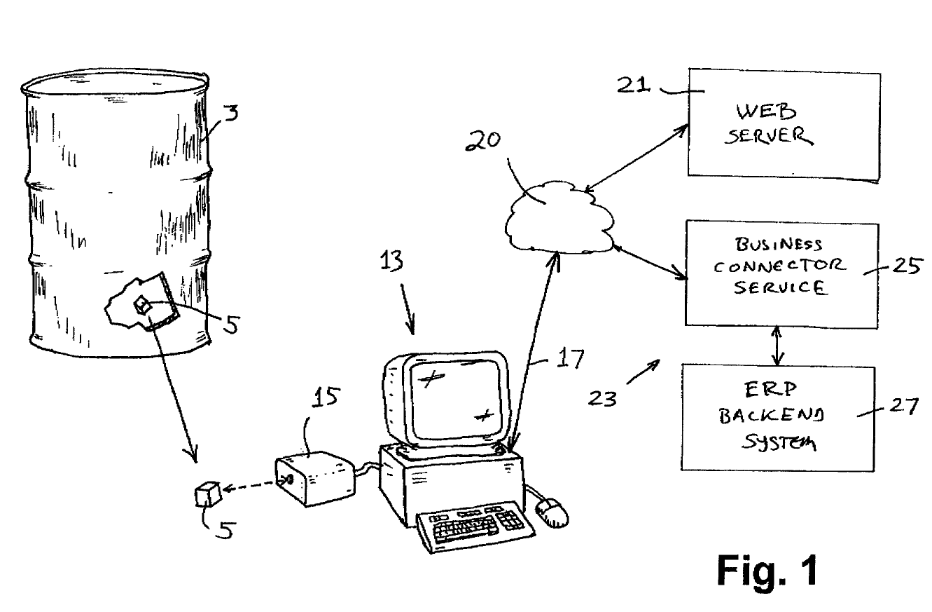

According to the present invention, a number of objects, preferably a very large number of objects, are each to be processed for a respective period of time, and environmental data for these objects is to be monitored during those periods. Ideally, where the product is kept or transported in a box or container such as container 3 in FIG. 1, the box or container is provided with a sensing device 5 therein, or, when this is not practical, attached to the outside of the container or supported nearby so as to be essentially in the same environment as the object being monitored.

The sensing device 5 is preferably a sensing device such as is sold by ESYS GmbH, a company located in Berlin, Germany.

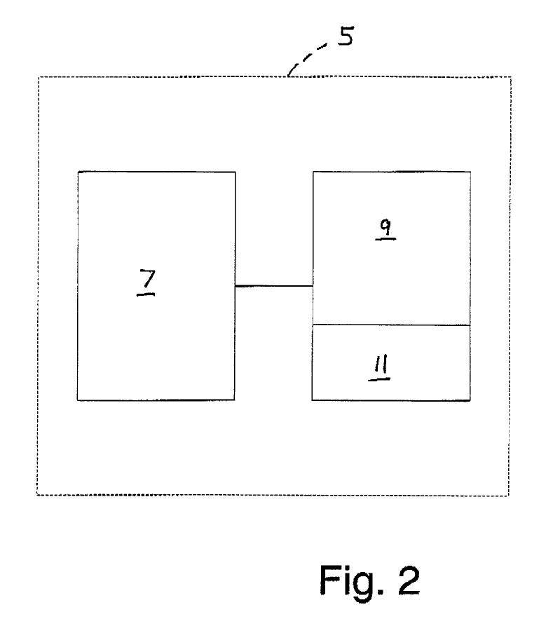

As can be seen in FIG. 2, the sensing device 5 of the preferred embodiment has an internal structure which comprises a sensor portion 7 connected with a processing circuit 9. The sensor 7 may detect any of a variety of environmental parameters. These can include, for example, temperature, motion, vibration or acceleration, light (whether visible or non-visible), radiation, or other types of waves of the environment such as RF signals or even sound waves. In addition, the sensor may detect the presence of one or more chemical substances, or may sense the humidity level in the environment of the sensing device 5. Most commonly, however, it is believed that this sensor will be a temperature sensor, because temperature is a particularly damaging factor to a large number of chemicals.

Circuitry 9 preferably runs a duty cycle so that it periodically accesses sensor 7 and determines the magnitude of whatever environmental parameter, such as temperature, is being monitored. The cycle interval may range from about once every second to once every several hours. The determination magnitude may be expressed in any variety of ways, although, a numerical value is particularly preferred.

Alternatively, other parameter-dependant logging methods might be used. For example, where a large amount of data is expected, the data stored may be a single bit derived by a test of whether the environmental parameter exceeds a preset threshold, e.g., when the temperature has exceeded a threshold temperature value, a “1” is logged, and to indicate that the temperature is below the threshold, a “0” is stored.

When the sensor data is processed by the circuitry 9, a record of the indication of magnitude reading of the sensor 7 is logged in data log memory 11 in the sensing device 5. Memory 11 in the preferred embodiment is a data storage area or cache in the device 5 with approximately 32 KB of usable memory, which is a suitable amount of storage for most applications.

As best seen in FIG. 1, when the product reaches the user, the sensing device 5 is removed from the container or from the vicinity of the object 3 for processing by an input computer generally indicated at 13. Computer 13 preferably includes an input device 15 which interrogates the sensing device 5, and the environmental log data from the logged records of the memory component 11 is downloaded to the computer 13.

The computer has a communications link 17 to computer data network 20. The computer data network 20 connects with a number of servers thereon including a web server 21 as well as a business system for data processing relating to the products in question generally indicated at 23. This business management system preferably comprises a business communications processor 25, also connected with the computer data network 20, and a management system such as an ERP back-end system 27 connected with the business communications processor 25 for receiving and processing the data that the communications processor 25 receives.

The reading device 15 is preferably an infrared reader. This reading device 15 transmits an infrared signal which is received by sensing device 5 and causes the sensing device 5 to send the stored environmental data log by wireless infrared transmission back to the reading device 15. This may take several seconds, especially if the entire memory of 32 KB or larger is being downloaded.

The sensing device 5 preferably has a unique respective identification number which is read as part of the downloaded data, or before or after the download, to identify exactly which sensing device 5 is being read, for the purposes of identifying the precise shipment the specific sensing device was assigned to.

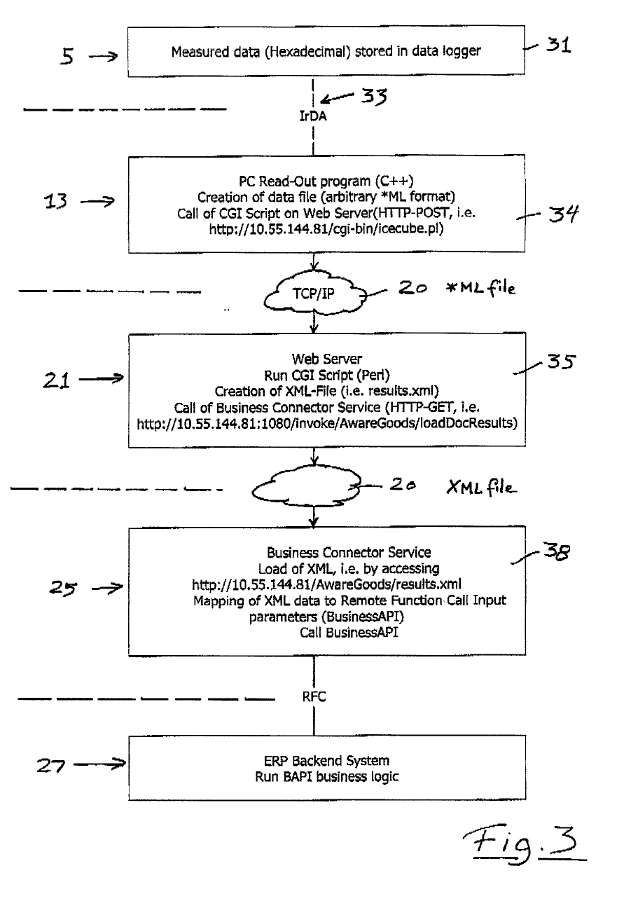

The flow of data among the components of the overall system is illustrated in the schematic flowchart of FIG. 3. Measurements are accumulated in the sensing device 5 (step 31) and downloaded wirelessly by infrared to computer 13. Alternatively, another wireless protocol, such as, e.g., Bluetooth data link, may be used for downloading the environmental data log.

The data log is downloaded into the computer 13, which converts the data log into a format which can be efficiently transmitted over network 20. Particularly preferred for this transmission is a markup language format such as an XML file. In this format, a fairly large file can be more readily transmitted over a local area network or another computer data network. Also, the markup language XML provides a data format that can easily be interpreted by human beings, and also is configured to be readable as a business-to-business (“B2B”) exchange standard by other third-party software. Because markup language files, including XML files, are transferable by the standard internet protocol http, these files can be easily distributed as desired through the network.

The web server 21 has a script that it runs responsive to being accessed by the computer 13 in step 34. This script is preferably a CGI script written in Perl, and, when run, it cooperates with computer 13 to receive the data log file which the computer has prepared from the data log downloaded from device 5, and if the file is not already in such a format, converts or maps it into a more appropriate format for transmission to the business system 23 (step 35).

The format of this file is also preferably a markup language format file, and most preferably a XML file. Again, this allows for flexibility in transmitting the data through a data network to the business processing system 23. The business processing system 23 translates the open and non-proprietory *ML data formate into ERP specific format and allows full bi-directional communication.

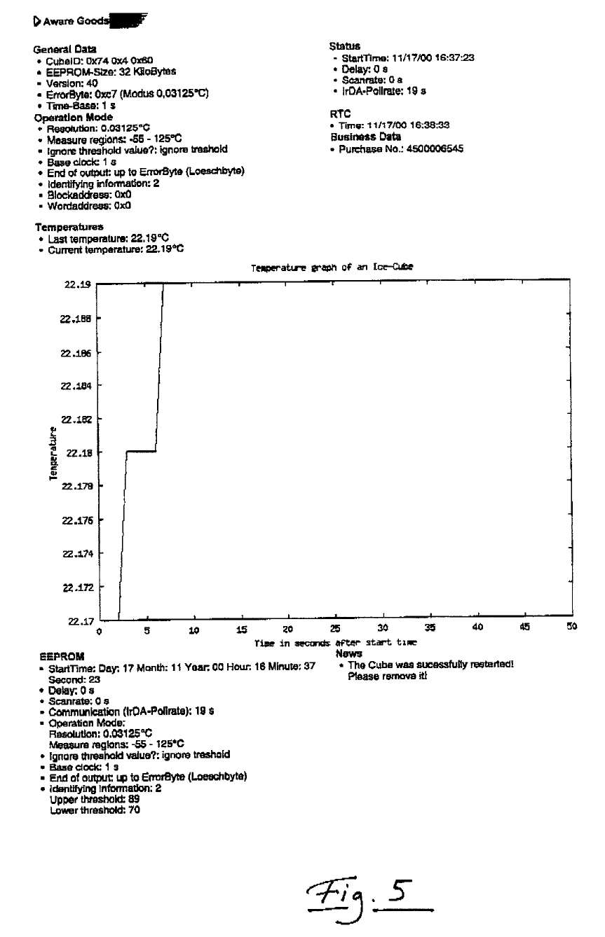

The web server 21 script also preferably prepares a HTML page containing a summary of the recorded environmental parameters, identifying numbers, business data, and any other information relating to the article. This HTML page can be accessed by any computer with browser on the network 20, and the user can view the HTML summary on a web page on his or her browser. An example of such a summary that would be expressed in the HTML is shown in FIG. 5.

When the web server 21 has converted the data to an appropriate XML or *ML data file, the data is transmitted over a network to the business communications processor 25. Most preferably, the incoming ML file is converted by the business communications processor into parameters of a remote function call which is transmitted to the ERP back-end system 27.

The data network connecting the server 21 to the business processing system 23 may be network 20 that connects the computer 13 to server 21, or it may be a separate network.

Alternatively, the function of web server 21 and the business connector 25 actions can be contained in a single computer system instead of two systems connected by the network. Where a single system is used, the computer downloads data from the sensor 5 and converts this data directly to a markup language file, preferable an XML file using software internal to the single computer, and consequently, no CGI script is necessary. This file is then sent over the network 20 directly to business connector 25. The computer 13 can also generate the HTML summary page to be accessed thereon over network 20. This arrangement increases the computational load on the read-out computer 13, but also eliminates the delay of communication with separate server 21 over network 20 and the attendant data conversion.

Preferably, the management system is an ERP backend system 27 such as the R/3 system sold by SAP AG of Walldorf, Germany, and the business communications processor is the Business Connector, also provided by SAP AG as part of the R/3 system.

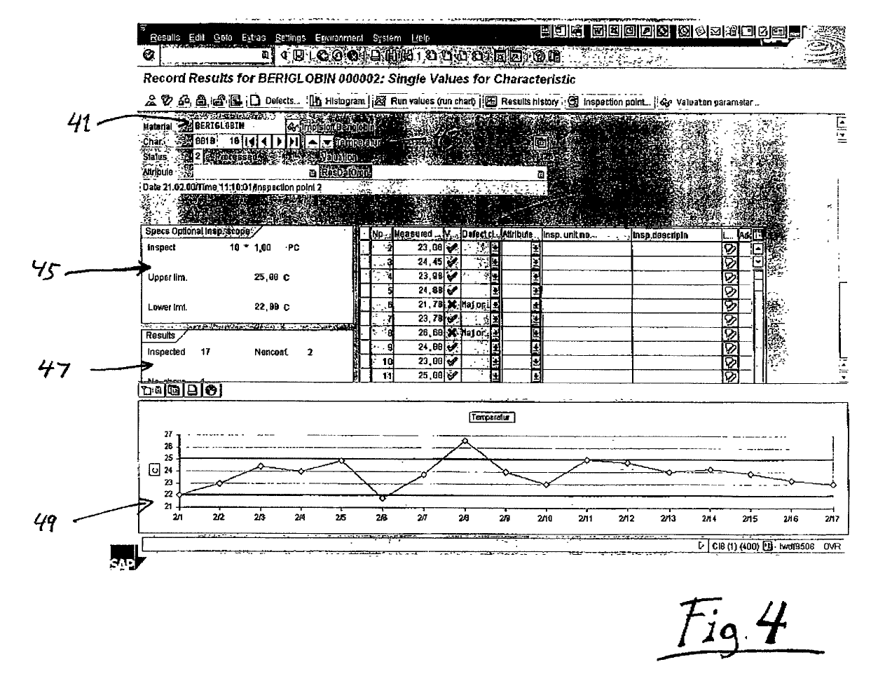

The ERP backend system 27 records the data which is transmitted thereto in an appropriate mass storage device. In addition, the ERP system 27 accesses any records relating to the shipment of goods, such as, e.g., other containers shipped at the same time as container 3, and produces from this data a report, such as the one shown in FIG. 4, which is transmitted back through the system for display on the monitor of computer 13, or on any other computer monitor communicating with the ERP system.

The report preferably includes details identifying the product in field 41, which, in the exemplary display, is the temperature sensitive product Beriglobin. Additional information is also provided in the display relating to the environmental parameter monitored (field 43), and the stability and environmental requirements of the given product (field 45). The display also preferably shows a summary of results for all related containers of a given group processed or shipped together. In addition, the report contains the actual environmental history in tabular and graph form (fields 48 and 49) with respect to the environmental parameter that was detected by the sensor 5, for review by a human operator where appropriate.

It will, of course, be understood that a wide range of reports may be configured which disply information of particular interest depending on the specific product and environmental parameter.

It will also be understood that the data may be used in a number of management contexts, such as inventory control. One of the primary applications of the system of the invention, however, is to allow a shipper and a buyer to assess responsibility for damaged goods, and various verification systems and certificates incorporating data from the sensor may be used.

The terms used herein should be considered as terms of description, not limitation, as those of skill in the art with this disclosure before then will be able to make changes and modivications therein without departing from the spirit of the invention.

What is claimed is:

1. A method of monitoring conditions to which an object is subjected over a period of time, said method comprising:
placing a sensing device in, on, or in the vicinity of the object for said period of time, said sensing device being movable with the object;
sensing an environmental parameter of the object with the sensing device for at least a plurality of moments in said period of time;
logging in a data recording component in the sensing device a record relating to magnitude of the environmental parameter for said sensing during said moments;
receiving in a computer system from said sensing device after the period of time log data from the logged records in the data recording component; and
creating on the computer a log data file containing said log data.

2. The method of claim 1, and further comprising
transmitting the log data file from the computer over a computer data network to a server thereon.

3. The method of claim 2 wherein the log data is in a server log data file in a format configured for transmission over the computer data network.

4. The method of claim 2 and the server functioning as or being connected with a business system for processing said server log data file.

5. The method of claim 4 and the business system being connected with the server by the computer data network or a second data network.

6. The method of claim 2 wherein the server log data file includes therein, or has transmitted there-therewith, unique identifying data identifying the sensing device.

7. The method of claim 1 and the environmental parameter being a parameter selected for the group consisting of temperature, motion, vibration, acceleration, visible light, non-visible light, radiation, humidity, presence of one or more chemical substances and sound.

8. The method of claim 1 wherein the environmental parameter is temperature.

9. The method of claim 1 wherein the environmental parameter is sensed periodically and the record is stored attendant thereto.

10. The method of claim 1 and the log data being transmitted wirelessly from the sensing device to the computer.

11. The method of claim 10 wherein the log data is transmitted by infrared communication to an infrared reader on the computer.

12. The method of claim 4 wherein the server log data file is in a markup language format.

13. The method of claim 12, and the business system comprising a communication processing system receiving the server log data file from the web server, and an ERP system connected therewith, the communication processing system transmitting data derived from the server log data file to the backend system.

14. The method of claim 13, and said communication processing system mapping said server log data file to a parameter of a remote function call to the ERP system.

15. The method of claim 14, and said communication processor being an SAP Business Connector Service.

16. The method of claim 15, wherein said ERP system is an SAP R/3 system.

17. The method of claim 4, wherein the business system comprises an ERP computer system that receives and stores data of the server log data file.

18. The method of claim 1, wherein a plurality of objects are monitored, each of said objects being provided with a respective sensing device having respective unique identifying data.

19. The method of claim 2, wherein the log data is transmitted from the computer to the server in a markup language format.

20. The method of claim 2 wherein said transmitting of the log data to the server includes accessing the server so as to start a script thereon, said script converting the log data file to a markup language file.

21. The method of claim 1 and transmitting the log data to a system, said system storing said log data on request to establish a history of environmental influences on the article.

22. A system for monitoring conditions to which an object is subjected by locating a sensing device located near or in the object and periodically sensing an environmental parameter to which the object is subjected, said sensing device having a data storage to which log data relating to said sensing is recorded, said system comprising:
a computer connected with a reading device that reads the log data from the sensor device, said computer downloading the log data from said sensing device and converting said log data to a data file; and
a record system communicating with the web server, said record system receiving the server log data file, storing the data therefrom and producing said data on request in a form to establish a history of environmental influences on the object.

23. The system of claim 22 and
the computer having a link connecting with a computer data network; and
the computer accessing a web server over the network so as to activate a script, said script converting the log data to a server log data file formatted for transmission over a data network.

24. The system of claim 23 and said record system receiving said server log data file over the network.

25. The system of claim 22, and
said record system including an ERP system processing the data and transmitting display data derived therefrom.

26. The system of claim 22, and said log data file of the computer being in a markup language format.

27. The system of claim 22 and said wireless reader transmitting an IR signal to the sensing device and receiving data therefrom by IR signal.

28. The system of claim 23 and said server log data file being in markup language format.

29. The system of claim 28, and said markup language format being XML.

30. The system of claim 22 and a plurality of additional objects being provided with further sensing devices operating on the sensing device but having distinct identifying data produced at download of the respective log data thereof;
said display data including data derived from the data downloaded from said further sensing devices.
